(19) United States
(12) Patent Application Publication
(10) Pub. No.: US 2004/0088123 A1
(43) Pub. Date: May 6, 2004

(54) Method for real-time monitoring of cardiac output and blood flow in arteries and apparatus for implementing the same

(76) Inventor: Zhong Ji, Seattle, WA (US)

Correspondence Address: Robert M. Storwick, P.O. Box 386, Mercer Island, WA, 98040, US

(21) Appl. No.: 10/286,082

(22) Filed: Nov. 1, 2002

(51) Int. Cl. G06F 19/00

(52) U.S. Cl. 702/45

(57) ABSTRACT

A method for monitoring volumetric blood flow rate and apparatus using the method is provided. It is fundamentally different from conventional methods such as Doppler ultrasound method, electromagnetic method, or tracer based methods. Volumetric blood flow rate through a blood vessel is considered a combination of two components, namely the pulsatile component and the diastolic residual component. In aorta and major arteries, pulsatile component is responsible for practically all the blood flow transport and this component can be measured based on the method of this invention. Unlike theoretical approaches popular in academic community, pulsatile wavelets are considered relatively independent among them and cannot be adequately represented by oscillatory wave theories mainly based on the linear superposition rule. The solitary waves approach is adapted for arterial pulsatile waves in this invention followed by theoretical analysis of the waves. Based on the understanding, the method uses measurements of spatial and temporal variations of arteries dimensions to derive the volumetric flow rate. Apparatuses using the method can monitor blood flow in arteries non-invasively while maintaining good accuracy since the measurement only depends on the accuracy of measuring the dimensions of the arteries.

### COPYRIGHT NOTICE

© Copyright 2002, Robert M. Storwick. All rights reserved.

A portion of the disclosure of this patent document contains material that is subject to copyright protection. The copyright owner has no objection to the facsimile reproduction by anyone of the patent document or the patent disclosure, as it appears in the United States Patent and Trademark Office patent file or records, but otherwise reserves all copyrights whatsoever.

### TECHNICAL FIELD

The present invention relates to methods and apparatus for monitoring fluid flow, and more particularly, to methods and apparatus for monitoring cardiac output and blood flow in arteries.

### BACKGROUND OF THE INVENTION

Measurement or estimation of volumetric blood flow within a blood vessel is essential in evaluate biological functions of human and animals in clinical and research applications. Blood flow measurement includes measurement of blood flow in aorta (Cardiac Output), in arteries, in capillaries and in veins. Among these, arterial blood flow rate is of most importance especially the cardiac output measurement.

Method of Blood Flow Measurement in General Classified in Two Categories, Invasive and Non-Invasive.

Invasive measurements are usually highly risky with surgery procedures involved. The measurement accuracy is usually highly dependent on vessel preparation during the implementation. In addition, the presence of the equipment or the tracer in the body may interfere with the physiology of the system, leading to possibilities of results not representative to normal physiological condition. Therefore, non-invasive measurement becomes more and more popular to avoid the risks, errors, and interference introduced by invasive procedures.

Most popular non-invasive measurement method today is Doppler ultrasound based flood flow measurement. Generally, in order to estimate the volumetric flow rate of blood through a blood vessel, the frequency shift of the ultrasound due to the movement of the media that reflects the beam is determined and the frequency shift is correlated to the velocity of the media. From this velocity measurement and a concurrent measurement of the diameter of the vessel, an estimate of the volumetric blood flow rate through the vessel may be made. However, the spatial resolution of the ultrasound beam depends on the frequency of the ultrasound beam. The accuracy of velocity measurement using Doppler ultrasound method is also subject to the velocity distribution of blood velocity profile, which is difficult to distinguish with ultrasound beam. In addition, the velocity measurement is highly dependent on the direction of the ultrasound beam, or the Doppler angle. This is a practical challenge to the operator of the instrument and several attempts have been made to address the difficulties.

Some methods of using MRI imaging techniques are proposed to measure the blood flow. However, high cost of the method and the slow responses of nuclear magnetic resonance signals relative to the rapid temporal variation of the blood flow in a cardiac cycle make the method undesirable to differentiate the waveform of volumetric blood flow in a cardiac cycle.

Other attempts have been proposed as methods based on Windkessel model of the cardiac cycle. They determine blood flow by taking consideration of arterial compliance using arterial pressure waveform and linearizing the non-linear arterial pressure function. The cardiac cycle in this approach is simplified and approximated by a RC circuit that composed of a resistor R and capacitor C with a time varying electric current supply. The voltage drop across the resistor is considered blood pressure drop and the current of the varying current is considered blood flow rate. Using the measurement of the blood pressure waveform, the solution of the differential equation representing the RC circuit is assumed to give a representation of the cardiac cycle. However, compliance of the artery wall, the arterial and peripheral resistance, and the pulse wave action are highly non-linear so that linear simplification of the system may not be good representation of the actual circulatory systems, which will inevitably lead to inaccuracy of this kind of methods.

The above-mentioned difficulties lead to this invention. One of the major advantages of the proposed method is that it is physically based. The accuracy of the measurement using the method depends only on the accuracy of the dimensional measurement of the concerned artery and no calibration required as shown in the theoretical aspect of the method. The method takes advantage of the existing understanding of non-linear solitary waves and applies to the pulsatile arterial wave propagation problems. The traditional measurement of volumetric blood flow rate due to pulsatile wave propagation is therefore transformed to measuring the spatial and temporal variation of internal diameter of arteries, thus offers greater potential to determine the blood flow rate in arteries accurately and timely.

### SUMMARY OF THE INVENTION

According to one aspect, the invention is a method for monitoring the rate of flow of a fluid through a predetermined section of an enclosed channel having an axis and a stretchable wall. The predetermined section is defined between first and second axially separated areas having first and second respective characteristic diameters. The method includes the steps of: a) measuring temporal waveforms of at least one of the diameters and their longitudinal changes for the predetermined section of the channel; b) calculating the propagating speed of diameter waveforms according to the longitudinal changes in the predetermined section of the channel; and c) determining the value of the velocity of the fluid based on the temporal waveforms and the propagating speed in the predetermined section of the channel.

According to a second aspect, the invention is an apparatus for monitoring the rate of flow of a fluid through a predetermined section of an enclosed channel having an axis and a stretchable wall. The predetermined section is defined between first and second axially separated areas having first and second respective characteristic diameters. The apparatus includes means for measuring temporal waveforms of at least one of the diameters and their longitudinal changes for the predetermined section of the channel. The apparatus also includes means for calculating the propagating speed of diameter waveforms according to the longitudinal changes in the predetermined section of the channel, and means for determining the value of the velocity of the fluid based on the temporal waveforms and the propagating speed in the predetermined section of the channel.

According to a third aspect, the invention is an apparatus for monitoring the rate of flow of a fluid through a predetermined section of an enclosed channel having an axis and a stretchable wall. The predetermined section is defined between first and second axially separated areas having first and second respective characteristic diameters. The apparatus includes a first measurement circuit to measure temporal waveforms of at least one of the diameters and their longitudinal changes for the predetermined section of the channel, a first calculation circuit to calculate the propagating speed of diameter waveforms according to the longitudinal changes in the predetermined section of the channel, and a circuit to determine the value of the velocity of the fluid based on the temporal waveforms and the propagating speed in the predetermined section of the channel.

### BRIEF DESCRIPTION OF THE DRAWINGS

FIG. 1 is a schematic diagram of a first embodiment of the inventive system.

FIG. 2 is a schematic diagram of a second embodiment of the inventive system.

FIG. 3 is an example of a display of data in accordance with the inventive system.

FIG. 4 is a schematic diagram of a nonlinear wave traveling along a section of an elastic tube.

FIG. 5 is a plot of a time history of the internal diameter measurements of a human radial artery during two cardiac cycles.

FIG. 6 is a plot of a time history of the blood flow in a radial artery during two cardiac cycles.

FIG. 7 is a block diagram of a method in accordance with a first embodiment of the present invention.

FIG. 8 is a block diagram of a method in accordance with a second embodiment of the present invention.

FIG. 9 is a plot of time histories of diameter and pressure in a blood vessel.

FIG. 10 is a plot of the correlation between diameter and pressure in a blood vessel.

FIG. 11 is a plot of a time history of blood wave velocity, as determined by the inventive system.

### DETAILED DESCRIPTION OF THE PREFERRED EMBODIMENT OF THE INVENTION

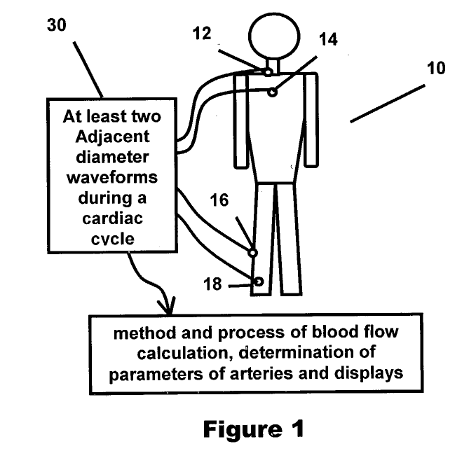

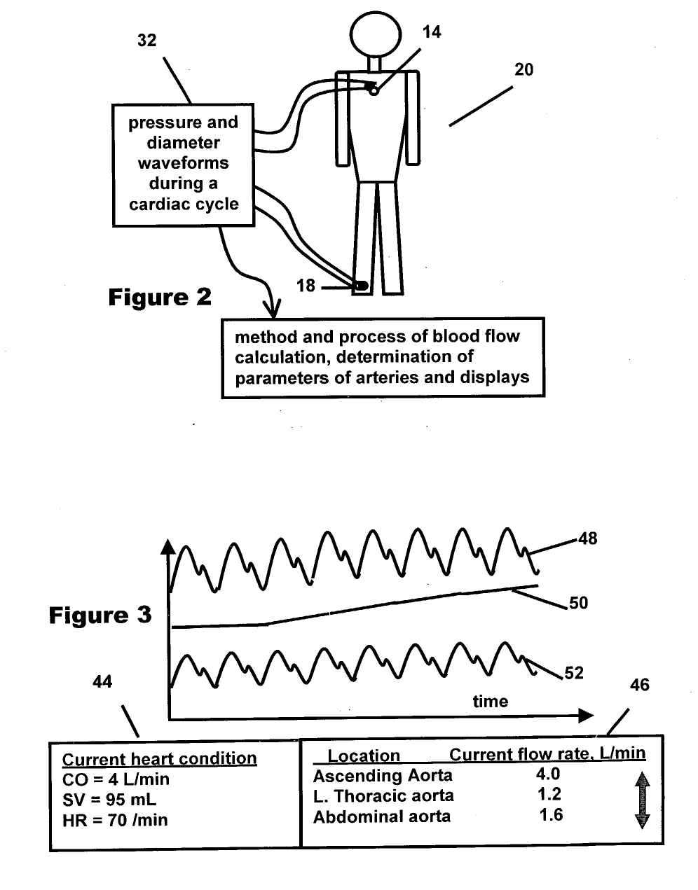

FIG. 1 is a schematic diagram of a first embodiment of the inventive system and FIG. 2 is a schematic diagram of a second embodiment of the inventive system. In the system 10, measurements of time histories of blood vessel diameters of a patient's blood vessels can be conveniently measured at adjacent locations in the patient's body, such as the adjacent locations including the neck location 12 and the chest location 14 or the adjacent locations including the leg location 16 and the foot location 18. In the system 20, measurements of time histories of respective blood vessel diameter and the corresponding histories of blood pressures within the patient's blood vessels can be conveniently measured at locations in the patient's body, such as the respective adjacent locations including the chest location 14 or the leg location.

In the system 10, at least one pair of the blood vessel diameter waveforms are received at an apparatus 30, where the waveforms are subjected to calculations that determine parameters of the arteries and display the desired parameters. In the system 20, at least one pair of the blood vessel diameter and pressure waveforms are received at an apparatus 32, where the waveforms are subjected to calculations that determine parameters of the arteries and display the desired parameters.

FIG. 3 is an example of a display of data in accordance with the inventive system. A conventional display device 40 can show three separate areas: a time history plot area 42, a current heart condition area 44, and a current flow rate area 46. The time history plot area 42 can show plots of such time histories are cardiac output 48, stroke volume 50, and thoracic aorta flow 52. The current heart condition area 44 can give current values such as carbon monoxide (CO), stroke volume (SV), and heart rate (HR), among others. The current flow rate area 46 can include instantaneous values of blood flow rates in locations within the patient's body, such as in the ascending aorta, a thoracic aorta, and a abdominal aorta.

Theoretical Considerations

The inventive method is based on the condition that there are two components of blood flow in blood circulatory systems. The first component is volumetric flow by means of wave propagation (pulsatile flow), and the second component is the volumetric flow due to the mean pressure gradient along the arteries to the veins (diastolic residual flow). The combination of these two components determines the blood flow at any location of the circulatory system.

The pulsatile component dominates in arteries as the oxygenated blood leaves the patient's heart and the valve, while the residual component dominates in veins as deoxygenated blood flows back to the patient's heart. Theoretically, immediately downstream of the valve, the diastolic residual flow component should be practically zero. As the wave propagates downstream through the patient's blood vessels, this component increases gradually and the pulsatile flow decreases. At the most downstream end of the circulatory system before the blood returns to the heart, the diastolic residual flow component dominates and the diastolic residual component becomes negligible. The researchers in the past have verified such general tendency.

The pulsatile wave propagation iems reported so far. Published measurements of arteries indicate that the wave front travels faster than its tail, exhibiting waver dispersion. The combination of the nonlinear effect and the dispersion effect makes the pulsatile wave retain a relatively stable form. Therefore, pulsatile waves in arteries behave similarly to solitary waves.

The inventive method is based on the assumption that pulsatile arterial waves are solitary with branches and tapering of the tubes provides the dispersion effect that compensates the nonlinear effect so that a relatively stable waveform can be maintained throughout the process of wave propagation. The validity of this assumption is proven by the fact that it is necessary to differentiate the nonlinear wave velocity in a slightly disturbed artery from the nonlinear wave velocity in a distended artery and the wave propagation velocity. The linear wave velocity at zero distension characterizes an artery filled with fluid and the nonlinear wave velocity for a distended artery reflects the states of the tube under internal pressure, and the wave propagation velocity represents what is happening in the system as a combination of traveling wave, wave reflection, wave distortion and other effects.

The inventive method is based on the fact that the pulse wave volume propagated through the same location explained above can approximate the flow volume during a cardiac cycle.

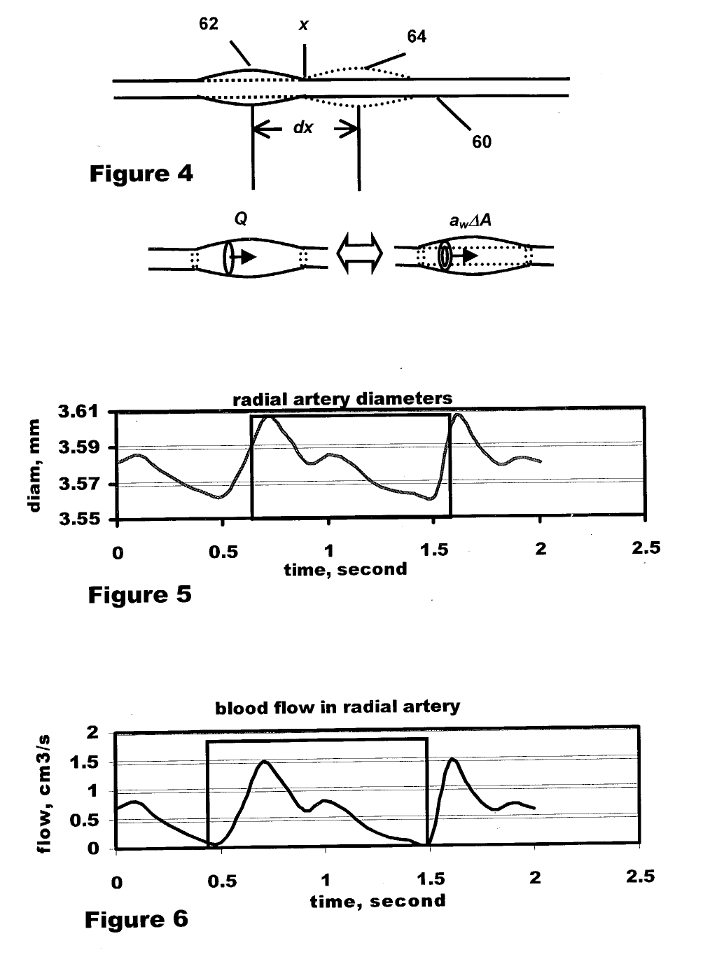

FIG. 4 is a schematic diagram of a solitary wave traveling along a section of an elastic tube. It is possible to examine a solitary wave traveling along a section of the elastic tube 60. To simplify the discussion, it is assumed that the tube 60 is very long relative to the wavelength of the wave. As the result of wave propagation, the wave profile 62 at the time t1 becomes a new profile 64 at time t2. To simplify the discussion, it is assumed that insignificant wave distortion takes place during the wave propagation at the location where flow is determined.

From FIG. 4, it is possible to see that, no matter how the wave propagation in blood circulatory system takes place, the resultant traveling of diameter waveform reflects volumetric flux. The net volume transport by the wave action over time should be equivalent to the blood flow at the location over the same period of time. With this in mind, it is possible to establish the equations that can be used to calculate the blood flow following the law of mass conservation.

The detected diameter waveform represents the result of wave distortion, reflection and other effects. An observer stationed at location x would experience negligible flow at both time t1 before the wave arrived, and at time t2 after the wave arrived. However, there is a net mass transport between the time t1 and t2. The volume of fluid between the original and the expanded portion moved a distance of dx between the time t1 and t2 with a wave speed a_{w}. This situation may be considered as an equivalent flow transport. For the observer at location x, the flow passing through that location should be equivalent to the volume of the wave propagating through the same location, since the diastolic residual flow is relatively small in major arteries.

The analysis starts with the one-dimensional continuity equation in respect to distance x and time t as:

$$\frac{\partial A}{\partial t} + \frac{\partial Q}{\partial x} = 0 ,$$

where Q is the flow rate and A is the cross sectional area. The equation implies that the decrease of cross sectional area should be balanced by the increase in cross-sectional flow rate.

The integration of the equation between x_{d} before the wave and x into the wave lead to the following

$${\int }_{{x}_{d}}^{x} \frac{\partial A}{\partial t} ⅆ x + {\int }_{{x}_{d}}^{x} \frac{\partial Q}{\partial x} ⅆ x = 0 ,$$

The integration of the second term leads to

$${\int }_{{x}_{d}}^{x} \frac{\partial A}{\partial t} ⅆ x + Q - {Q}_{d} = 0 ,$$

Since the shape remains unchanged during the propagation for a solitary wave, the wave propagation velocity a_{w} at different phases of the wave should remain constant. The wave propagation requires that

dx=±a_{w}dt.

Considering that the flow at location d is zero, i.e., the diastolic residual flow Q_{d} is negligible, the above equation can be written as

$$Q = \pm {\int }_{{t}_{d}}^{t} \frac{\partial A}{\partial t} {a}_{w} ⅆ t .$$

Therefore we have

Q=±a_{w}(A−A_{d}).

This equation clearly indicates that the flow at a section is proportionally related to the increase in cross-sectional area. Thus, the equation that effectively converts the change in vessel diameter and wave velocity to volumetric flow can be established according to the above theoretical discussions.

The following equation that effectively converts the change in vessel radius and wave speed a_{w} to volumetric flow rate can be established according to above discussions.

Q=π(d²−d_{d}²)a_{w}/4 1

Here d is the internal diameter of the vessel at any point in time, and d_{d} is the diameter at diastolic pressure. If both sides of the above equation are divided by the cross sectional area, the result is the cross-sectional averaged flow velocity, u:

u=a_{w}(1−d_{d}²/d²) 2

Integration of Equation (1) over a cardiac cycle T from the beginning of the wave leads to the volume of flow during the whole cardiac cycle:

$$V = ( π / 4 ) {\int }_{o}^{Γ} {a}_{w} ( {d}^{2} - {d}_{d}^{2} ) ⅆ t \qquad 3$$

Applying Equations 1, 2 or 3 to any location in arteries where wave volumetric transport dominates leads to the blood flow or cross sectional velocity at that location. As a special situation, when applying Equation 3 to an ascending aorta, both the stroke volume and the cardiac output can be computed.

The average flow rate can be calculated according to the heart rate (R) and the flow volume as:

Q=V*R liters/min 4

Determination of the Wave Speed and the Diameter Waveforms

In order to determine the blood flow accurately, it is necessary to acquire the radius of arteries and the corresponding wave speed required by Equations 1, 2, 3 and 4 reliably and accurately. Transmural pressure can also be used in conjunction with Equations 6 and 8 to determine the wave velocity and radius waveforms as shown in the following example.

The measurement of lumen diameter can be easily done non-invasively through several conventional ultrasound methods, namely, M-mode ultrasound, B-mode ultrasound, and ultrasound echo-tracking methods with acceptable precision and accuracy. A near-infrared technique can be another non-invasive alternative. The method can also be used with invasive measurements of internal vessel diameter waveforms. The inventive method does not exclude any means that can provide the diameter waveform accurately.

In addition to the diameter waveform, it is also necessary wave velocity waveform in order to apply Equations 1, 2, 3 and 4. One way of determining the wave velocity at the location of measurements is to measure the diameter waveforms at two adjacent locations with a predetermined vessel distance. The wave velocity waveform can be determined by measuring the arrival times of characteristic points of the diameter waveforms such as the peak of the waveform. The wave velocity at the points can be determined by taking the ratio between the length of the segment and the time delay, since the length of the segment is known, and the delay can be determined by timing the arrival of the point in diameter waveforms.

The simplest way of determining the wave velocity waveform between the two locations is to use the peak and foot wave velocities calculated from the diameter waveforms and then average the two wave velocities to approximate the wave velocity for the entire cardiac cycle. This approach is valid if the difference between the wave velocities is relatively small. The other way is to interpolate the wave velocities between the peak and the foot by scaling the change according to the corresponding diameter measurements. The scale could be established linearly, so that the increase in wave velocity is proportional to the distension of the artery based on the diastolic wave velocity.

Example 1 describes how the method is used.

### EXAMPLE 1

Echo-tracking ultrasound measurements of internal diameters in human radial artery are used as an example of the disclosed method of determining the blood flow. The internal diameter waveform of radial artery is taken with the wave velocity measured concurrently. FIG. 5 is a plot of a time history of the internal diameter measurements of a human radial artery during two cardiac cycles, and FIG. 6 is a plot of a time history of the blood flow in a radial artery during two cardiac cycles. The wave velocity was determined to be 560 cm/s. By using the wave velocity and a diameter waveform for the radial artery, the blood flow waveform is determined as shown in FIG. 6. As can be seen, the heart rate of the subject is about 60/min which gives the period of 1 second. Based on the flow rate determined in FIG. 8, the blood volume through the radial artery during the cardiac cycle is determined to be 0.61 cm³.

Mechanics of the Arterial Wall Distension

In order to use the proposed method to determine the pulsatile blood flow, both the diameter waveform and the wave propagation velocity waveform need to be determined. In that regard, it is helpful to briefly discuss the interaction between the arterial wall and the distension before describe the methods of processing the waveforms for flow calculation.

Here is given an example of how the linear wave speed, the solitary wave velocity, the diameter, and the transmural pressure are related to one another. It should be noted here that the following specific formula is for demonstration purpose of the proposed method and apparatus only. The proposed method is not limited to the proposed functions. Other relationships among the characteristics of the vessel wall, dilation of the vessel, transmural pressure and the solitary wave velocity may be used to serve the same purposes.

In a recent study of the mechanic properties of the wall of the arteries, it was found that the distension of the wall subject to the transmural pressure is a function of the Young's modulus of elasticity E₀, the diameter of the vessel d₀, the thickness of the artery wall e₀, under zero transmural pressure and the coefficient of hyperelasticity of the wall Γ. One of the simple ways of describing the nonlinear relationship can be written as:

h=(e₀E₀/ρg)(1+Γ(d−d₀)²/d₀²)(d−d₀)/d² 5

Here h is the pressure head at the location, ρ is the density of blood, and g is the acceleration of gravity. Based on Equation 5, the relationship between the wave propagation speed and the distension of the wall is derived as

a_{w}=a₀(d₀(2d₀/d−1+Γ(2d₀/d+1)(d/d₀−1)²)/d)^{1/2} 6

Here a_{w} is the solitary wave velocity at the location, ρ is the density of blood, g is the acceleration of gravity, and a₀ is the linear wave speed, defined as:

a₀=(e₀E₀/ρd₀)^{1/2} 7

Notably, this is commonly known as Moens-Korteweg formula.

Equation 5 can also be written in terms of linear wave speed as

h=(a₀²d₀/gd)(1+Γ(d/d₀−1)²)(1−d₀/d) 8

As can be seen, there are three parameters, namely a₀, d₀ and Γ, to be determined in order to use Equations 6 and 8. Once the parameters are determined, the following three variables can be used to describe the states of the vessel:

Distension of the vessel as described by the diameter, d

Wave velocity, a_{w}

Transmural pressure as expressed by pressure head, h

The above discussions lead to another alternative of determining the wave velocity waveform using the diameter waveform measurement. The variables a₀, Γ, and d₀ in Equations 6 and 8 define the mechanical characteristics of the vessel at the location and should be important parameters to relate the three variables. Three pairs of measurements of two of the three variables are necessary to determine a₀, Γ, and d₀.

At a given distension of the vessel, if the wave speed is measured, it is possible to write an equation based on Equation 6. From the distension of the vessel at the crest, the incisura, and the foot of a cardiac cycle, and corresponding wave velocities, it is possible to establish three equations using Equation 6 that relates a₀, Γ, and d₀ for the characteristics of the vessel. Solving the three equations results in the three parameters. Then it is possible to determine the wave speed waveform according to the diameter waveform.

The wave velocity waveform could also be determined by relating the wave velocity to the deformation of the vessel and pressure if both the pressure waveform and diameter waveform at same location are available. According to the discussion of distension of artery under pressure, any two of the three variables (the diameter of the vessel d, the wave velocity a_{w}, and the pressure head h) are sufficient to determine the third variable as long as the parameters for the vessel wall and the density of the fluid are given according to Equations 6 and 8. Apparently, a₀, Γ, and d₀ in Equations 6 and 8 define the mechanical characteristics of the vessel at the location and should be important parameters to relate the three variables and the measurements of the variables can be used to determine them indirectly.

Three pairs of measurements of two of the three variables are necessary to determine a₀, Γ, and d₀. For example, at a given distension of the vessel, if the wave velocity is measured, we can write an equation using Equation 6 that relates a₀, Γ, and d₀. If the distension of the artery at the peak, the incisura, and the foot of a cardiac cycle waveforms and corresponding wave velocities are known, it is possible to establish three equations. Solving the three equations gives the three parameters that fit the measurements. Then it should be able to determine the wave speed given the distension waveform of the artery. Likewise, if the diastolic pressure, systolic pressure and the pressure at the incisura point and the corresponding wave speeds or vessel distension are known, it is possible to write three equations using Equation 1 that relates the three parameters.

Technically, measurements of any two of the three variables (d, a_{w}, h) are sufficient to determine the third variable as long as the parameters for the vessel wall and the density of the fluid are given. Below is an example demonstrating how to determine the wave velocity waveform indirectly using measurements of both the diameter and the pressure waveforms.

Result Reporting

The results consist of blood flow rate at locations where the measurements were taken. Instantaneous blood velocity, peak velocity, and blood flow distribution to branch arteries can also be displayed continuously according to the beat-by-beat measurements.

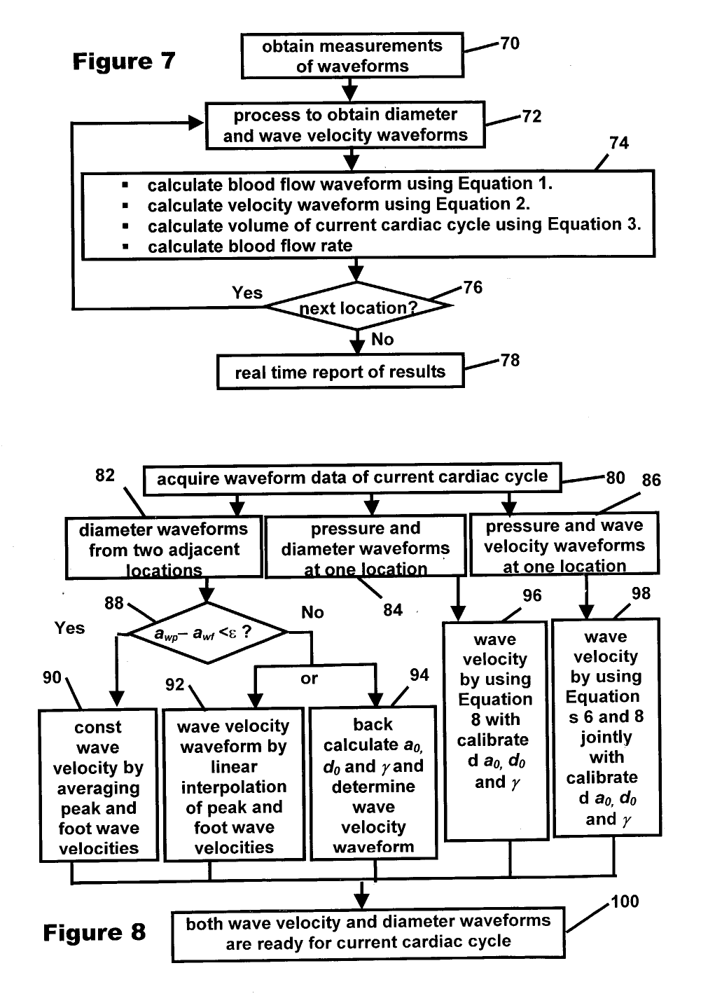

FIG. 7 is a block diagram of a method in accordance with a first embodiment of the present invention. The method begins with obtaining measurements of the waveforms to be analyzed (block 70). These waveforms are then processed to obtain diameter and wave velocity waveforms (block 72). From the results of this processing, the blood flow waveform can be calculated using Equation 1, the velocity waveform can be calculated using Equation 2, the flow volume during the current cardiac cycle can be calculated using Equation 3, and/or the blood flow rate can be calculated (block 74). In decision block 76, the method then decides whether to analyze a next location. If the decision is to analyze a next location, the method returns to block 72, where further diameter and wave velocity waveforms are obtained. If the decision is against analyzing a next location, the method moves to block 78, where the real time results are reported.

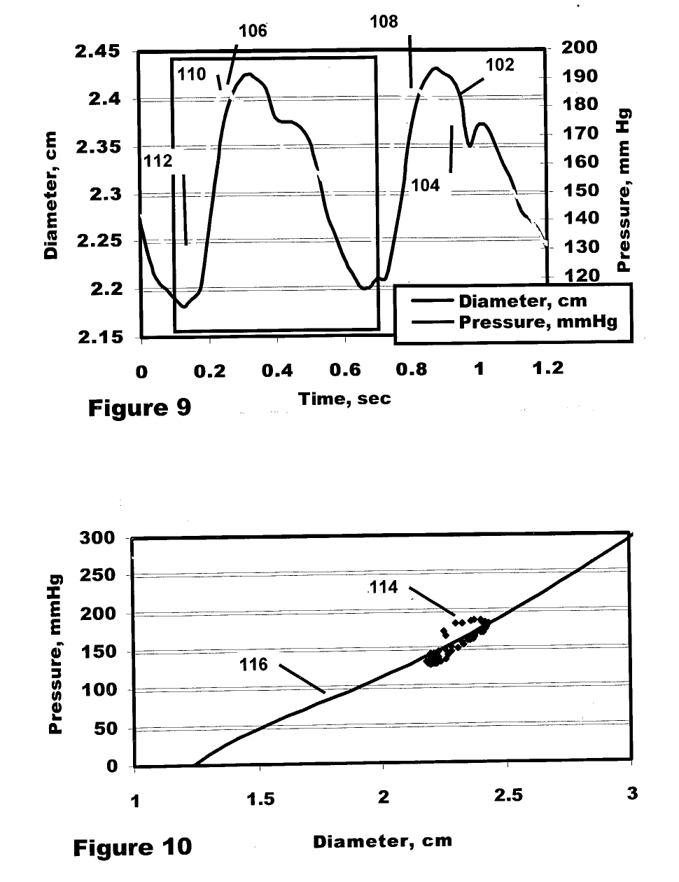

FIG. 9 is a block diagram of a method in accordance with a second embodiment of the present invention. The method begins at block 80, where waveform data of the current cardiac cycle are acquired. Next, depending upon the type of analysis desired, the method can take any one of three possible forms. One form is to use diameter waveforms from two adjacent locations (block 82). Another form is to use diameter and pressure waveforms at a single location (block 84). A third form is to use pressure and wave velocity waveforms at a single location (block 86).

From block 82, the method determines the amount by which the peak wave velocity a_{w}_{_{—}}ₚₑₐₖ exceeds the foot wave velocity a_{w}_{_{—}}_{foot} (decision block 88). If the peak wave velocity a_{w}_{_{—}}ₚₑₐₖ exceeds the foot wave velocity a_{w}_{_{—}}_{foot} by only a small amount (ε), the method calculates a constant wave velocity by averaging a_{w}_{_{—}}ₚₑₐₖ and a_{w}_{_{—}}_{foot} (block 90). On the other hand, if the peak wave velocity a_{w}_{_{—}}ₚₑₐₖ exceeds the foot wave velocity a_{w}_{_{—}}_{foot} by more than the small amount ε, the method has two approaches to determining the wave velocity waveform. In one approach, the wave velocity waveform is determined by interpolation of a_{w}_{_{—}}ₚₑₐₖ and a_{w}_{_{—}}_{foot} (block 92). In the other approach, the wave velocity is determined by back-calculating a₀, d₀ and Γ, and using the results to determine the wave velocity waveform (block 94).

From block 84, the method calculates the wave velocity waveform using Equation 8 with calibrated values of a₀, d₀ and Γ (block 96).

From block 86, the method calculates the wave velocity waveform using Equations 6 and 8 jointly with calibrated values of a₀, d₀ and Γ (block 98).

The method then moves from blocks 90, 92, 94, 96 and 98 to block 100, where wave velocity and diameter waveforms are calculated for the current cardiac cycle.

### EXAMPLE 2

FIG. 9 is a plot of time histories of diameter and pressure in a blood vessel. The set of diameter measurements from Greenfield et al. (1962) shown in FIG. 9 is used as an example to explain how the method proposed here can be applied. FIG. 9 shows the time histories of blood vessel diameter 102 and blood pressure 104, showing consecutive blood pressure pulses 106 and 108.

FIG. 9 indicates that the diameter change of the human ascending aorta is between 2.2 cm to 2.42 cm in response to the pressure pulses 106 and 108. The period of the pulses 106 and 108 is about 0.6 seconds and the heart rate is about 100 beats per minute. Both systolic and diastolic pressures (110 and 112 respectively) of the subject are very high at the time when the measurements were taken.

The cardiac output and peak velocity can be estimated using the time series data set. Since the wave speed was not measured in this data set, the solitary wave speed is determined indirectly using Equation 6 according to the parameters determined using Equation 8 and the data set.

FIG. 10 is a plot of the correlation between diameter and pressure in a blood vessel. FIG. 10 shows the relationship between the radius and the pressure. The dots 114 in FIG. 10 represent the measurements from the literature and the line 116 represents Equation 8 with appropriate set of a₀, the cardiac cycle is about 142 cm³, and the cardiac output is about 14.2 liters per minute, based on the stroke volume and the heart rate.

Based on the peak wave speed, it is also possible to calculate the peak velocity at the location using Equation 2 as follows:

v=534[1−(2.2/2)²/(2.42/2)²]=93 cm/s

The results of both cardiac output and peak flow velocity are in the high end of normal physiological range published in literature.

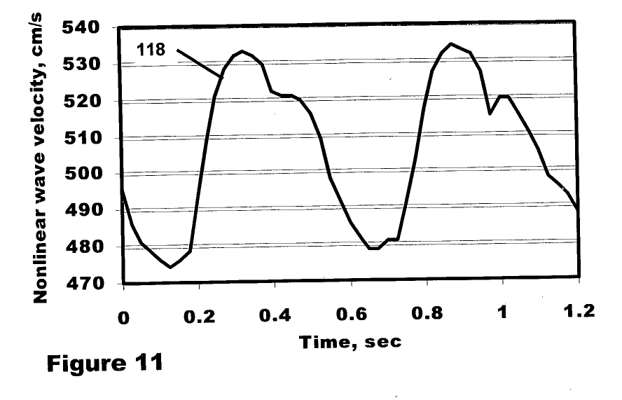

FIG. 11 is a plot of a time history of blood wave velocity, as determined by the inventive system. The plot in FIG. 11 shows the corresponding calculated wave velocity waveform 118.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. A method for monitoring the rate of flow of a fluid through a predetermined section of an enclosed channel having an axis and a stretchable wall, the predetermined section being defined between first and second axially separated areas having first and second respective characteristic diameters, the method comprising the steps of:
a) measuring temporal waveforms of at least one of the diameters and their longitudinal changes for the predetermined section of the channel;
b) calculating the propagating speed of diameter waveforms according to the longitudinal changes in the predetermined section of the channel; and
c) determining the value of the velocity of the fluid based on the temporal waveforms and the propagating speed in the predetermined section of the channel.

2. The method of claim 1, further comprising the step of:
d) calculating the value of the rate of flow according to the temporal waveforms and the velocity of the fluid.

3. The method of claim 1, wherein the fluid is blood.

4. The method of claim 1, wherein the channel is an artery of a living subject.

5. The method of claim 1, wherein step a) further includes measuring temporal waveforms of at least two diameters within the predetermined section of the enclosed channel.

6. The method of claim 1, wherein step b) further includes normalizing the diameter waveforms by determining an amplitude feature value for each of the diameter waveforms and dividing one of the amplitude feature values by the other amplitude feature value, thereby establishing a normalization factor that contributes to determining the propagating speeds of the diameter waveforms.

7. The method of claim 1, wherein step b) further includes averaging the velocity of the fluid in accordance with cross-sections determined by the diameter waveforms.

8. The method of claim 1, further comprising the steps of:
d) performing steps a)-c) repetitively for a series of times of arrival; and
e) calculating a series of average values of average values of the rate of flow of the fluid.

9. The method of claim 8, wherein step e) includes calculating the average time difference of the times of arrival if the arrival time of the waveform is smaller than an error limit determined by a realistic measurement error for flow monitoring.

10. The method of claim 1, wherein the flow is pulsative, and further comprising the steps of:
d) performing steps a)-c) repetitively for a series of pulses; and
e) calculating a series of average values of average values of the rate of flow of the fluid.

11. The method of claim 10, wherein step e) includes calculating the average time difference of the times of arrival if the arrival time of the waveform is smaller than an error limit determined by a realistic measurement error for flow monitoring.

12. The method of claim 1, further comprising the step of:
f) displaying the value of the velocity of the fluid.

13. The method of claim 1, further comprising the step of:
f) determining whether there is a reflective average waveform showing blockage of the enclosed channel having an axis.

14. The method of claim 13, wherein the reflective average waveform has a comparative tail showing blockage of the enclosed channel.

15. An apparatus for monitoring the rate of flow of a fluid through a predetermined section of an enclosed channel having an axis and a stretchable wall, the predetermined section being defined between first and second axially separated areas having first and second respective characteristic diameters, the apparatus comprising:
means for measuring temporal waveforms of at least one of the diameters and their longitudinal changes for the predetermined section of the channel;
means for calculating the propagating speed of diameter waveforms according to the longitudinal changes in the predetermined section of the channel; and
means for determining the value of the velocity of the fluid based on the temporal waveforms and the propagating speed in the predetermined section of the channel.

16. The apparatus of claim 15, further comprising:
means for calculating the value of the rate of flow according to the temporal waveforms and the velocity of the fluid.

17. The apparatus of claim 15, wherein the fluid is blood.

18. The apparatus of claim 15, wherein the channel is an artery of a living subject.

19. The apparatus of claim 15, wherein the means for measuring temporal waveforms further includes means for measuring temporal waveforms of at least two diameters within the predetermined section of the enclosed channel.

20. The apparatus of claim 15, wherein the means for calculating further includes means for normalizing the diameter waveforms by determining an amplitude feature value for each of the diameter waveforms and dividing one of the amplitude feature values by the other amplitude feature value, thereby establishing a normalization factor that contributes to determining the propagating speeds of the diameter waveforms.

21. The apparatus of claim 15, wherein the means for calculating further includes means for averaging the velocity of the fluid in accordance with cross-sections determined by the diameter waveforms.

22. The apparatus of claim 15, further comprising:
means for repetitively causing the means for measuring, the means for calculating and the means for determining to operate on portions of the temporal waveforms; and
means for calculating a series of average values of the rate of flow of the fluid.

23. The apparatus of claim 22, wherein the means for calculating a series of average values includes means for calculating the average time difference of the times of arrival if the arrival time of the waveform is smaller than an error limit determined by a realistic measurement error for flow monitoring.

24. The apparatus of claim 15, wherein the flow is pulsative, the apparatus further comprising:
means for repetitively causing the means for measuring, the means for calculating and the means for determining to operate on a series of pulses; and
means for calculating a series of average values of the rate of flow of the fluid.

25. The apparatus of claim 24, wherein the means for calculating a series of average values includes means for calculating the average time difference of the times of arrival if the arrival time of the waveform is smaller than an error limit determined by a realistic measurement error for flow monitoring.

26. The apparatus of claim 25, further comprising means for displaying the value of the velocity of the fluid.

27. The apparatus of claim 25, further comprising means for determining whether there is a reflective average waveform showing blockage of the enclosed channel having an axis.

28. The apparatus of claim 27, wherein the reflective average waveform has a comparative tail showing blockage of the enclosed channel.

29. An apparatus for monitoring the rate of flow of a fluid through a predetermined section of an enclosed channel having an axis and a stretchable wall, the predetermined section being defined between first and second axially separated areas having first and second respective characteristic diameters, the apparatus comprising:
a first measurement circuit to measure temporal waveforms of at least one of the diameters and their longitudinal changes for the predetermined section of the channel;
a first calculation circuit to calculate the propagating speed of diameter waveforms according to the longitudinal changes in the predetermined section of the channel; and
a circuit to determine the value of the velocity of the fluid based on the temporal waveforms and the propagating speed in the predetermined section of the channel.

30. The apparatus of claim 29, further comprising:
a second calculation circuit to calculate the value of the rate of flow according to the temporal waveforms and the velocity of the fluid.

31. The apparatus of claim 29, wherein the fluid is blood.

32. The apparatus of claim 29, wherein the channel is an artery of a living subject.

33. The apparatus of claim 29, wherein the first measurement circuit further includes a second measurement circuit to measure temporal waveforms of at least two diameters within the predetermined section of the enclosed channel.

34. The apparatus of claim 29, wherein the first calculation circuit further includes a normalization circuit to normalize the diameter waveforms by determining an amplitude feature value for each of the diameter waveforms and dividing one of the amplitude feature values by the other amplitude feature value, thereby establishing a normalization factor that contributes to determining the propagating speeds of the diameter waveforms.

35. The apparatus of claim 29, wherein the first calculation circuit further includes an averaging circuit to average the velocity of the fluid in accordance with cross-sections determined by the diameter waveforms.

36. The apparatus of claim 29, further comprising:
a repetition circuit to repetitively cause the first measurement circuit, the first calculation circuit and the circuit to determine the value of the velocity of the fluid to operate on portions of the temporal waveforms; and
a second calculation circuit to calculate a series of average values of the rate of flow of the fluid.

37. The apparatus of claim 36, wherein the second calculation circuit includes a third calculation circuit to calculate the average time difference of the times of arrival if the arrival time of the waveform is smaller than an error limit determined by a realistic measurement error for flow monitoring.

38. The apparatus of claim 29, wherein the flow is pulsative, the apparatus further comprising:
a repetition circuit to repetitively cause the measurement circuit, the first calculation circuit and the circuit to determine the value of the velocity of the fluid to operate on a series of pulses; and
a second calculation circuit to calculate a series of average values of the rate of flow of the fluid.

39. The apparatus of claim 38, wherein the first calculation circuit includes a second calculation circuit to calculate the average time difference of the times of arrival if the arrival time of the waveform is smaller than an error limit determined by a realistic measurement error for flow monitoring.

40. The apparatus of claim 39, further comprises a display circuit to display the value of the velocity of the fluid.

41. The apparatus of claim 39, further comprising a circuit to determine whether there is a reflective average waveform showing blockage of the enclosed channel having an axis.

42. The apparatus of claim 41, wherein the reflective average waveform has a comparative tail showing blockage of the enclosed channel.
